(19) United States
(12) Patent Application Publication
(10) Pub. No.: US 2025/0196339 A1
(43) Pub. Date: Jun. 19, 2025

(54) AUTOMATED CONSTRAINED MANIPULATION

(71) Applicant: Boston Dynamics, Inc., Waltham, MA (US)

(72) Inventors: Navid Aghasadeghi, Boston, MA (US); Robert Eugene Paolini, Cambridge, MA (US)

(21) Appl. No.: 18/978,536

(22) Filed: Dec. 12, 2024

Related U.S. Application Data
(60) Provisional application No. 63/611,024, filed on Dec. 15, 2023.

(51) Int. Cl. B25J 9/16

(52) U.S. Cl. CPC B25J 9/163

(57) ABSTRACT

Techniques for automated constrained manipulation are provided. In one aspect, a method includes receiving a request for manipulating a target constrained object and receiving perception data from at least one sensor of a robot. The perception data indicative of the target constrained object. The method also includes receiving a semantic model of the target constrained object generated based on the perception data and determining a location for a robotic arm of the robot to interact with the target constrained object based on the semantic model and the request. The method further includes controlling the robotic arm to manipulate the target constrained object based on the location for the robotic arm to interact with the target constrained object.

### CROSS-REFERENCE TO RELATED APPLICATION(S)

This application claims the benefit of priority of U.S. Provisional Patent Application No. 63/611,024, filed Dec. 15, 2023, the disclosure of which is hereby incorporated by reference in its entirety herein. Any and all applications for which a foreign or domestic priority claim is identified in the Application Data Sheet as filed with the present application are hereby incorporated by reference under 37 CFR 1.57.

### BACKGROUND

### Technological Field

This disclosure relates to manipulation of objects using a robotic arm.

### Description of the Related Technology

One task which may be performed by a robotic arm is manipulation of objects which have constrained movement, such as doors or switches. These constraints to the movement of such objects introduce additional complexity to the manipulation of such objects using robotic arms.

### SUMMARY OF CERTAIN INVENTIVE ASPECTS

In one aspect there is provided a method, comprising: receiving, by data processing hardware of a robot, a request for manipulating a target constrained object; receiving, from at least one sensor of the robot, perception data indicative of the target constrained object; receiving, by the data processing hardware, a semantic model of the target constrained object generated based on the perception data; determining, by the data processing hardware, a location for a robotic arm of the robot to interact with the target constrained object based on the semantic model and the request; and controlling, by the data processing hardware, the robotic arm to manipulate the target constrained object based on the location for the robotic arm to interact with the target constrained object.

In some embodiments, the target constrained object is constrained in at least one degree of freedom (DoF) of movement.

In some embodiments, the request comprises an indication of the target constrained object and an instruction for manipulating the target constrained object.

In some embodiments, the request includes natural language, the method further comprising: parsing the natural language using a large language model to generate an indication of the target constrained object and an instruction for manipulating the target constrained object.

In some embodiments, the method further comprises: displaying a camera view received from a camera of the robot on a screen of a remote device; and receiving the request as an input of the remote device.

In some embodiments, the method further comprises displaying, on the screen, a simulated movement of the target constrained object.

In some embodiments, receiving the semantic model comprises determining, by the data processing hardware, the semantic model by: identifying a graspable portion of the target constrained object within the perception data and identifying a location where the graspable portion is attached to a remainder of the target constrained object; identifying a plurality of axes of the target constrained object; identifying an axis of rotation of the target constrained object; and/or identifying an axis of the target constrained object that can be grasped.

In some embodiments, receiving the semantic model comprises determining, by the data processing hardware, the semantic model by: applying segmentation to the perception data to identify different portions of the target constrained object; and applying a computer vision algorithm to determine a set of principal axes of the target constrained object, identify where a handle is attached to a remainder of the target constrained object, and identify one or more other geometrical properties of the target constrained object.

In some embodiments, the method further comprises: determining a pose of the robotic arm for grasping the target constrained object based on the semantic model.

In some embodiments, the method further comprises: resolving one or more ambiguities in the pose of the robotic arm for grasping the target constrained object based on the semantic model, one or more limits associated with joints of the robotic arm, and/or capabilities of actuators of the robotic arm.

In some embodiments, the one or more ambiguities comprise whether a gripper of the robotic arm is flipped by 180 degrees and/or a plurality of poses of the robotic arm that are consistent with the location for the robotic arm to interact with the target constrained object.

In some embodiments, the method further comprises: determining a pose for the robot based on the location for the robotic arm to interact with the target constrained object, wherein controlling the robotic arm to manipulate the target constrained object is further based on the pose for the robot.

In some embodiments, the pose for the robot comprises a pose for a body of the robot and a pose for one or more legs of the robot.

In some embodiments, the method further comprises: determining a set of parameters for manipulating the target constrained object based on the location for the robotic arm to interact with the target constrained object, wherein controlling the robotic arm to manipulate the target constrained object is further based on the set of parameters.

In some embodiments, the set of parameters comprises an initial direction to apply wrench to manipulate the target constrained object and/or a task type associated with the target constrained object.

In some embodiments, controlling the robotic arm to manipulate the target constrained object is further based on the request.

In some embodiments, the method further comprises: determining, by the data processing hardware, the semantic model of the target constrained object based on the perception data.

In another aspect, there is provided a legged robot comprising: a body; a robotic arm configured to manipulate a target constrained object; two or more legs coupled to the body; at least one sensor configured to generate perception data; and a control system in communication with the body and the robotic arm, the control system comprising data processing hardware and memory hardware in communication with the data processing hardware, the memory hardware storing instructions that when executed on the data processing hardware cause the data processing hardware to: receive a request for manipulating the target constrained object; receive the perception data from the at least one sensor, the perception data indicative of the target constrained object; receive a semantic model of the target constrained object generated based on the perception data; determine a location for the robotic arm to interact with the target constrained object based on the semantic model and the request; and controlling the robotic arm to manipulate the target constrained object based on the location for the robotic arm to interact with the target constrained object.

In some embodiments, the target constrained object is constrained in at least one degree of freedom (DoF) of movement.

In some embodiments, the request comprises an indication of the target constrained object and an instruction for manipulating the target constrained object.

In some embodiments, the request includes natural language, and wherein the instructions further cause the data processing hardware to: parse the natural language using a large language model to generate an indication of the target constrained object and an instruction for manipulating the target constrained object.

In some embodiments, the robot further comprises: a camera, wherein the instructions further cause the data processing hardware to: display a camera view received from the camera on a screen of a remote device; and receive the request as an input of the remote device.

In some embodiments, the instructions further cause the data processing hardware to: display, on the screen, a simulated movement of the target constrained object.

In some embodiments, receiving the semantic model comprises determining the semantic model by: identifying a graspable portion of the target constrained object within the perception data and identifying a location where the graspable portion is attached to a remainder of the target constrained object; identifying a plurality of axes of the target constrained object; identifying an axis of rotation of the target constrained object; and/or identifying an axis of the target constrained object that can be grasped.

In some embodiments, receiving the semantic model comprises determining the semantic model by: applying segmentation to the perception data to identify different portions of the target constrained object; and applying a computer vision algorithm to determine a set of principal axes of the target constrained object, identify where a handle is attached to a remainder of the target constrained object, and identify one or more other geometrical properties of the target constrained object.

In some embodiments, the instructions further cause the data processing hardware to: determine a pose of the robotic arm for grasping the target constrained object based on the semantic model.

In some embodiments, the instructions further cause the data processing hardware to: resolve one or more ambiguities in the pose of the robotic arm for grasping the target constrained object based on the semantic model, one or more limits associated with joints of the robotic arm, and/or capabilities of actuators of the robotic arm.

In some embodiments, the one or more ambiguities comprise whether a gripper of the robotic arm is flipped by 180 degrees and/or a plurality of poses of the robotic arm that are consistent with the location for the robotic arm to interact with the target constrained object.

In some embodiments, the instructions further cause the data processing hardware to: determine a pose for the robot based on the location for the robotic arm to interact with the target constrained object, wherein controlling the robotic arm to manipulate the target constrained object is further based on the pose for the robot.

In some embodiments, the pose for the robot comprises a pose for a body of the robot and a pose for one or more legs of the robot.

In some embodiments, the instructions further cause the data processing hardware to: determine a set of parameters for manipulating the target constrained object based on the location for the robotic arm to interact with the target constrained object, wherein controlling the robotic arm to manipulate the target constrained object is further based on the set of parameters.

In some embodiments, the set of parameters comprises an initial direction to apply wrench to manipulate the target constrained object and/or a task type associated with the target constrained object.

In some embodiments, controlling the robotic arm to manipulate the target constrained object is further based on the request.

In some embodiments, the instructions further cause the data processing hardware to: determine, by the data processing hardware, the semantic model of the target constrained object based on the perception data.

In still another aspect, there is provided a non-transitory computer-readable medium having stored therein instructions that, when executed by data processing hardware of a robot, cause the data processing hardware to: receive a request for manipulating a target constrained object; receive, from at least one sensor of the robot, perception data indicative of the target constrained object; receive a semantic model of the target constrained object generated based on the perception data; determine a location for a robotic arm of the robot to interact with the target constrained object based on the semantic model and the request; and control the robotic arm to manipulate the target constrained object based on the location for the robotic arm to interact with the target constrained object.

In some embodiments, the target constrained object is constrained in at least one degree of freedom (DoF) of movement.

In some embodiments, the request comprises an indication of the target constrained object and an instruction for manipulating the target constrained object.

In some embodiments, the request includes natural language, wherein the instructions, when executed by the data processing hardware, further cause the data processing hardware to: parse the natural language using a large language model to generate an indication of the target constrained object and an instruction for manipulating the target constrained object.

In some embodiments, the instructions, when executed by the data processing hardware, further cause the data processing hardware to: display a camera view received from a camera of the robot on a screen of a remote device; and receive the request as an input of the remote device.

In some embodiments, the instructions, when executed by the data processing hardware, further cause the data processing hardware to: displaying, on the screen, a simulated movement of the target constrained object.

In some embodiments, receiving the semantic model comprises determining the semantic model by: identifying a graspable portion of the target constrained object within the perception data and identifying a location where the graspable portion is attached to a remainder of the target constrained object; identifying a plurality of axes of the target constrained object; identifying an axis of rotation of the target constrained object; and/or identifying an axis of the target constrained object that can be grasped.

In some embodiments, receiving the semantic model comprises determining the semantic model by: applying segmentation to the perception data to identify different portions of the target constrained object; and applying a computer vision algorithm to determine a set of principal axes of the target constrained object, identify where a handle is attached to a remainder of the target constrained object, and identify one or more other geometrical properties of the target constrained object.

In some embodiments, the instructions, when executed by the data processing hardware, further cause the data processing hardware to: determine a pose of the robotic arm for grasping the target constrained object based on the semantic model.

In some embodiments, the instructions, when executed by the data processing hardware, further cause the data processing hardware to: resolve one or more ambiguities in the pose of the robotic arm for grasping the target constrained object based on the semantic model, one or more limits associated with joints of the robotic arm, and/or capabilities of actuators of the robotic arm.

In some embodiments, the one or more ambiguities comprise whether a gripper of the robotic arm is flipped by 180 degrees and/or a plurality of poses of the robotic arm that are consistent with the location for the robotic arm to interact with the target constrained object.

In some embodiments, the instructions, when executed by the data processing hardware, further cause the data processing hardware to: determine a pose for the robot based on the location for the robotic arm to interact with the target constrained object, wherein controlling the robotic arm to manipulate the target constrained object is further based on the pose for the robot.

In some embodiments, the pose for the robot comprises a pose for a body of the robot and a pose for one or more legs of the robot.

In some embodiments, the instructions, when executed by the data processing hardware, further cause the data processing hardware to: determine a set of parameters for manipulating the target constrained object based on the location for the robotic arm to interact with the target constrained object, wherein controlling the robotic arm to manipulate the target constrained object is further based on the set of parameters.

In some embodiments, the set of parameters comprises an initial direction to apply wrench to manipulate the target constrained object and/or a task type associated with the target constrained object.

In some embodiments, controlling the robotic arm to manipulate the target constrained object is further based on the request.

In some embodiments, the instructions, when executed by the data processing hardware, further cause the data processing hardware to: determine, by the data processing hardware, the semantic model of the target constrained object based on the perception data.

### BRIEF DESCRIPTION OF THE DRAWINGS

FIG. 1 is a schematic view of an example robot for manipulating a constrained object.

FIG. 2 is an example block diagram of an arm controller configured to manipulate constrained objects.

FIG. 3 is an example of a remote device which can receive input from an operator via a user interface and generate the request.

FIG. 4 is an example block diagram of the constrained object parameter generator.

FIG. 5 illustrates a method for manipulating a target constrained object.

FIG. 6 is a schematic view of an example computing device that may be used to implement the systems and methods described in this document.

### DETAILED DESCRIPTION

One common task for robots to perform is interacting with objects in the environment. Certain objects may be constrained in their degrees of freedom of movement. For example, constrained objects such as switches, levers, doors, etc. may only be able to rotate around an axis of rotation, while other constrained objects such as sliding doors, drawers, buttons, etc. may only be able to move along a linear path.

Certain techniques for manipulating constrained objects involve receiving commands from an operator connected remotely. However, these techniques can have drawbacks including poor situational awareness, latency, and unintuitive control, which can slow down the overall manipulation task.

As described herein, aspects of this disclosure relate to generating a semantic model of constrained objects which is used to automate aspects of controlling a robot to manipulate such constrained objects.

### Example Robotic Systems

Many robots include multi-axis articulable appendages configured to execute complex movements for completing tasks, such as material handling or industrial operations (e.g., welding, gluing, and/or fastening). These appendages, also referred to as manipulators or arms, typically include an end-effector or hand attached at the end of a series appendage segments or portions, which are connected to each other by one or more appendage joints. The appendage joints cooperate to configure the appendage in a variety of poses within a space associated with the robot. Here, the term “pose” refers to the position and orientation of the appendage. For example, the pose of the appendage may be defined by coordinates (x, y, z) of the appendage within a workspace (for instance, in a Cartesian space), and the orientation may be defined by angles (for instance, Ox, Oy, Oz) of the appendage within the workspace. In use, the appendage may need to manipulate partially constrained objects by applying forces to move the object along or about one or more unconstrained axes.

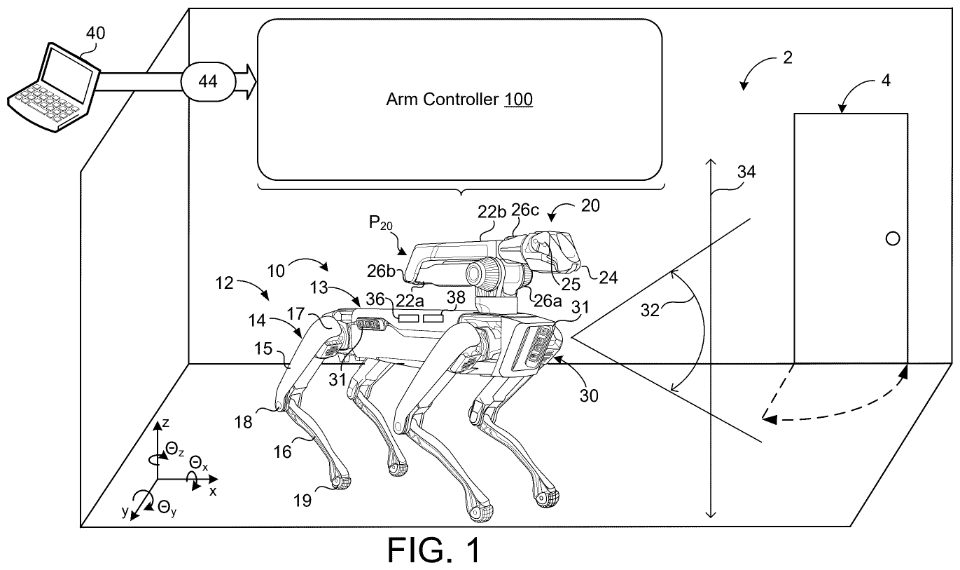

Referring to FIG. 1, a robot or robotic device 10 includes a base 12 having a body 13 and two or more legs 14. Each leg 14 may have an upper leg portion 15 and a lower leg portion 16. The upper leg portion 15 may be attached to the body 13 at an upper joint 17 (i.e., a hip joint) and the lower leg portion 16 may be attached to the upper leg portion 15 by an intermediate joint 18 (i.e., a knee joint). Each leg 14 further includes a contact pad or foot 19 disposed at a distal end of the lower leg portion 16, which provides a ground-contacting point for the base 12 of the robot 10.

In some implementations, the robot 10 further includes one or more appendages, such as an articulated arm 20 or manipulator disposed on the body 13 and configured to move relative to the body 13. Moreover, the articulated arm 20 may be interchangeably referred to as a manipulator, an appendage arm, or simply an appendage. In the example shown, the articulated arm 20 includes two arm portions 22a, 22b rotatable relative to one another and the body 13. However, the articulated arm 20 may include more or fewer arm portions without departing from the scope of the present disclosure. A third arm portion 24 of the articulated arm, referred to as an end effector 24, hand 24, or gripper 24, may be interchangeably coupled to a distal end of the second portion 22b of the articulated arm 20 and may include one or more actuators 25 for gripping/grasping objects 4.

The articulated arm 20 includes a plurality of joints 26a-26c disposed between adjacent ones of the arm portions 22a, 22b, 24. In the example shown, the first arm portion 22a is attached to the body 13 of the robot 10 by a first two-axis joint 26a, interchangeably referred to as a shoulder 26a. A single-axis joint 26b connects the first arm portion 22a to the second arm portion 22b. The second joint 26b includes a single axis of rotation and may be interchangeably referred to as an elbow 26b of the articulated arm 20. A second two axis joint 26c connects the second arm portion 22b to the hand 24, and may be interchangeably referred to as a wrist 26c of the articulated arm 20. Accordingly, the joints 26a-26c cooperate to provide the articulated arm 20 with five degrees of freedom (i.e., five axes of rotation). While the illustrated example shows a five-axis articulated arm 20, the principles of the present disclosure are applicable to robotic arms having any number of axes. Furthermore, the principles of the present disclosure are applicable to robotic arms mounted to different types of bases, such as mobile bases including one or more wheels or stationary bases.

The robot 10 also includes a vision system 30 with at least one imaging sensor or camera 31, each sensor or camera 31 capturing image data or sensor data of the environment 2 surrounding the robot 10 with an angle of view 32 and within a field of view 34. The vision system 30 may be configured to move the field of view 34 by adjusting the angle of view 32 or by panning and/or tilting (either independently or via movement of the robot 10) the camera 31 to move the field of view 34 in any direction. Alternatively, the vision system 30 may include multiple sensors or cameras 31 such that the vision system 30 captures a generally 360-degree field of view around the robot 10. The camera(s) 31 of the vision system 30, in some implementations, include one or more stereo cameras (e.g., one or more RGBD stereo cameras providing both color (RGB) and depth (D)). In other examples, the vision system 30 includes one or more radar sensors such as a scanning light-detection and ranging (LIDAR) sensor, or a scanning laser-detection and ranging (LADAR) sensor, a light scanner, a time-of-flight sensor, or any other three-dimensional (3D) volumetric image sensor (or any such combination of sensors). The vision system 30 provides image data or sensor data derived from image data captured by the cameras or sensors 31 to the data processing hardware 36 of the robot 10. The data processing hardware 36 is in digital communication with memory hardware 38 and, in some implementations, may be a remote system. The remote system may be a single computer, multiple computers, or a distributed system (e.g., a cloud environment) having scalable/elastic computing resources and/or storage resources.

In the example shown, the robot 10 executes an arm controller 100 on the data processing hardware 36 of the robot. In some implementations, at least a portion of the arm controller 100 executes on a remote device 40 in communication with the robot 10. Optionally, the arm controller 100 may execute on a remote device 40 and the remote device 40 may provide an object manipulation request 44 to the robot 10 to move/control the articulated arm 20 for manipulating a constrained object 4.

The arm controller 100 of the robot 10 controls moving the articulated arm 20 between arm poses P₂₀. For instance, the articulated arm 20 may need to move from a start pose P₂₀ to a target pose P₂₀ when the robot 10 is executing the request 44. For instance, in a scenario when the robot 10 needs to open a door while navigating in an environment, the robot arm controller 100 will need to move the articulated arm 20 from a first pose P₂₀ where the door is in a closed position to a second pose P₂₀ where the door is in an open position.

Movements and poses of the robot 10 and robot appendages 14, 20 may be defined in terms of a robot workspace based on a Cartesian coordinate system. In the example of the robot 10 provided in FIG. 1, the robot workspace may be defined by six dimensions including the translational axes x, y, z and rotational axes Θₓ, Θ_{y}, Θ_{z} (SE(3) (manifolds). As discussed below, actions of the robot 10 and/or the robot arm 20 may be defined using lower-dimensional spaces or manifolds including less axes than the number of axes (six) of the workspace. For example, the request 44 may be constrained to a single axis within the workspace so that path parameters 248 can be efficiently computed along the single axis. Appendages 14, 20 of the robot 10 may also be described in terms of a joint space, which refers to a space representing all possible combinations of joint configurations of a robot appendage, and is directly related to the number of degrees of freedom of the robot appendage. For instance, a robot arm having n degrees of freedom will have an n-dimensional joint space. In the present example, the articulated arm has five degrees of freedom defining a five-dimensional joint space.

### Techniques for Manipulating Constrained Objects

Robots can be controlled to perform various tasks including manipulating objects in the environment. A family of difficult or dangerous tasks that can be automated with robotics includes manipulating levers, electrical switches, handles, and other similar objects (also referred to as “affordances”). Affordances can be characterized by being constrained in how they move in the environment. Objects which have constrained movement can present unique challenges for a robot. Examples of objects which may have constrained movement include doors, switches, levers, shutters, ball valves, drawers, sliding doors, cranks, wheels, knobs, locks, etc. Certain objects may constrain movement of the robot without the object itself moving, for example, when the robot wipes a table or dusts a shelf.

There are a number of applications for manipulating constrained affordances using robots in various industries. These tasks can be found in numerous industries, such as energy (e.g., levers, wheels, knobs, switches), search and rescue (e.g., doors, cabinets, or turning valves in hard-to-reach areas), and others. The manipulation of certain constrained objects in performing these tasks can often be dangerous (e.g., high voltage breakers), difficult (e.g., manipulating constrained objects in remote or hard to reach environments), and/or non-compliant with safety regulations.

The present disclosure relates to systems and techniques for automating aspects of constrained object manipulation tasks, thereby improving the success rate of the manipulation and/or reducing the amount of information required from an operator in order to perform the tasks.

When a robot encounters a new object in the environment, the robot may not have any semantic information (also referred to as a semantic understanding or a semantic model) on whether the object is constrained in its degrees-of-freedom of movement. One technique for obtaining a semantic model on objects in the environment is to receive semantic information from an operator of the robot. In some circumstances, the operator can provide instructions and semantic information to the robot remotely via teleoperation.

As used herein, a semantic model can refer to data representing the physical structure of an object as well as data representing the degrees of freedom of movement of the object or a portion thereof. For example, the semantic model can include a three-dimensional representation of the object along with any axes defining the direction(s)/rotation(s) in which the object can be manipulated.

Controlling a robot to grasp or otherwise interact with constrained objects via teleoperation, or other semi-autonomous strategies, can still pose challenges that lead to poor manipulation of the constrained objects. For example, teleoperation for grasping constrained objects can result in many challenges including poor situational awareness, latency, and unintuitive control. Each of these challenges can lead to significantly slowing down the grasping process and/or reducing the quality of the grasp of the object. Semi-automated grasping techniques are also typically not able to provide reliable grasps for constrained objects, particularly when there are various affordance and/or environmental differences.

One result of this gap in the field is a slow grasping pipeline and often poor grasps of constrained objects. Poor grasp quality can lead to higher chances of slippage and losing grasp, and thus significantly reduce the probability of successfully manipulating constrained objects.

Another challenge in manipulating constrained objects post-grasp is that often the post-grasp operation involves initializing the operation with initial parameters and/or operator-provided hints. The parameters and hints can include, for example, the initial direction to apply wrench (e.g., force and/or torque) and/or the broad type of task to be performed. The selection of these parameters and/or hints by the user introduces another challenge and another possibility for task failure due to incorrect parameter selection.

Aspects of this disclosure provide systems and techniques for addressing one or more of the above-indicated challenges by automating certain tasks involved in manipulating constrained objects. In some embodiments, a robot generates a semantic model of constrained objects, which can improve the grasp quality by the robot's manipulator. Furthermore, the robot can use the semantic model to determine a set of parameters for the post-grasp operation (e.g., manipulating the constrained object), leading to a more seamless and reliable solution for the robot manipulating these affordances.

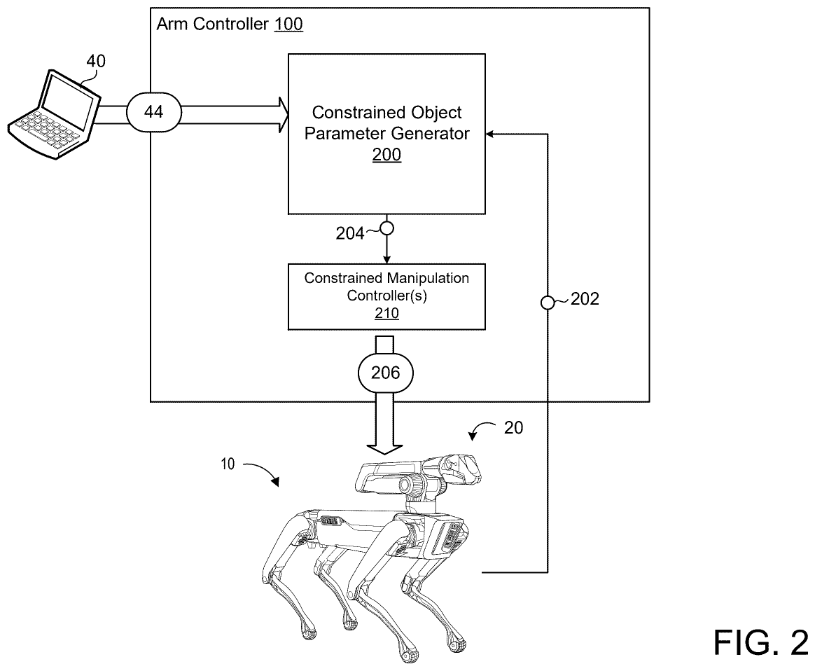

FIG. 2 is an example block diagram of an arm controller 100 configured to manipulate constrained objects. With reference to FIG. 2, the arm controller 100 includes a constrained object parameter generator 200 and one or more constrained manipulation controller(s) 210. The constrained object parameter generator 200 is configured to receive or obtain requests 44 from the remote device 40 and receive perception data 202 from the robot 10 (e.g., from a vision system 30 of the robot 10). The request 44 can include instructions from an operator for the robot 10 to manipulate a constrained object in the environment (e.g., the environment 2 shown and described above in FIG. 1). The constrained object parameter generator 200 is further configured to generate a set of parameters 204 that provide information related to how an object can be manipulated once the object has been grasped.

The constrained manipulation controller(s) 210 are configured to receive the set of parameters 204 from the constrained object parameter generator 200 and generate instructions 206 to control movement of the robot 10 and/or the articulated arm 20 to manipulate the constrained object. In contrast to the inputs provided to typical joint or end-effector controllers, in some embodiments the set of parameters 204 provided to the constrained manipulation controller(s) 210 can include “high-level” inputs, such as: “turn the valve by 90 degrees,” task type, initial wrench direction, etc. The constrained manipulation controller(s) 210 can be configured to generate the instructions 206 based on these types of “high-level” inputs.

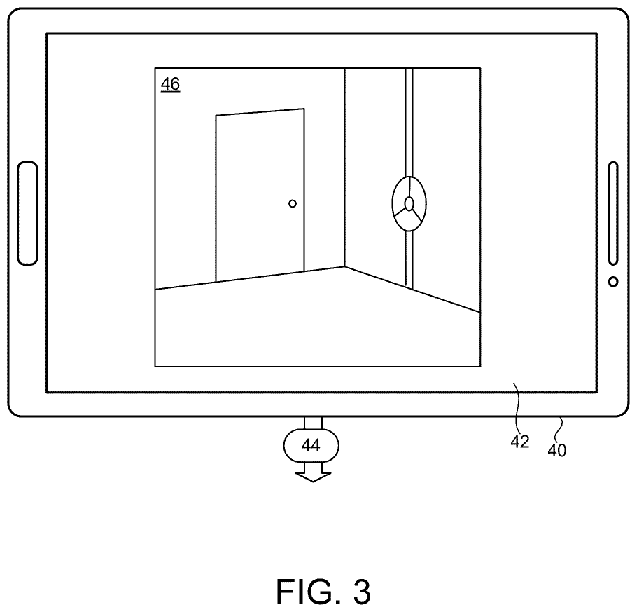

FIG. 3 is an example of a remote device 40 which can receive input from an operator via a user interface 42 and generate a request 44. A user may interact with a user interface 42 displayed on a screen in communication with the remote device 40 to select one or more constrained objects in an environment (e.g., the environment 2 shown and described above in FIG. 1) of a robot (such as the robot 10 shown and described above in FIG. 1 or 2) for the request 44. For example, the user interface 42 may graphically display a task location window 46 for displaying a location in the robot environment. The remote device 40 can receive a selection of a constrained object within the task location window 46 to be manipulated by the robot. For example, the user can tap, click, or otherwise select the location of a constrained object displayed within the task location window 46. The remote device 40 can generate the request 44 based on the input received form the user selecting the constrained object.

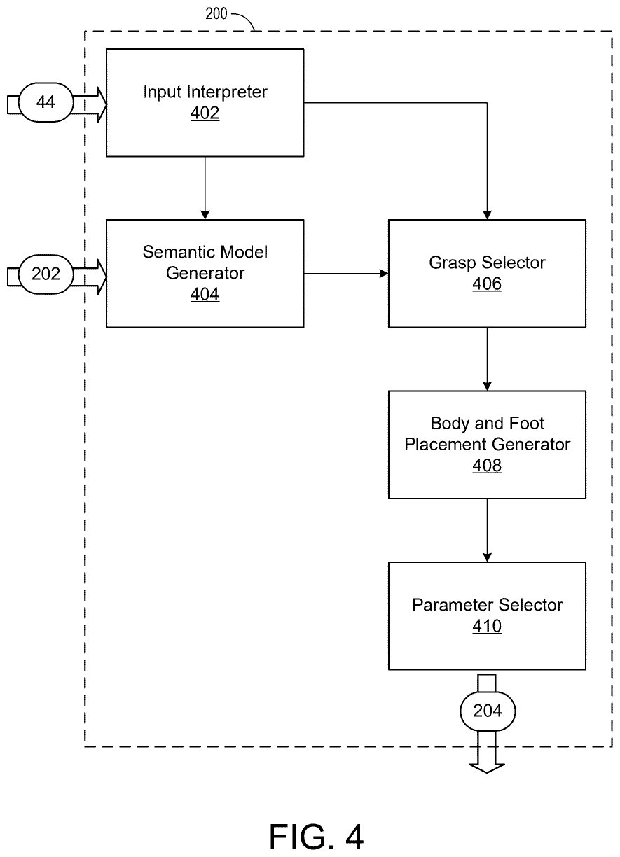

FIG. 4 is an example block diagram of the constrained object parameter generator 200. The constrained object parameter generator 200 includes an input interpreter 402, a semantic model generator 404, a grasp selector 406, a body and foot placement generator 408, and a parameter selector 410.

The constrained object parameter generator 200 is configured to receive the request 44 and the perception data 202 as inputs. The input interpreter 402 is configured to receive the request 44 and interpret the request 44 to extract the indication of the target object and the instructions for manipulating the target constrained object. In some embodiments, the input interpreter 402 is configured to determine a type of the task associated with the request 44.

In order to automate the generation of the set of parameters 204 for manipulating constrained objects, the request 44 can include an indication of a target object (e.g., a constrained object or interest) and an instruction for manipulating the target object. In some embodiments, the request 44 can include natural language or an indicator selected from a displayed image. Examples of natural language input include: “grasp the yellow lever,” “open the drawer”, “flip the switch,” “turn the yellow handle by 45 degrees clockwise,” etc. In some embodiments, the instruction for manipulating the target object can include a degree to which the target object should be manipulated. Examples of the degree to which the target object should be manipulated include: an input angle, for example, “turn the lever by 45 degrees”, or another high-level command like “flip the switch.”

The input interpreter 402 can be configured to perform natural language processing to parse any natural language included in the request 44. For example, in some embodiments, the input interpreter 402 can include a large language model (LLM) configured to parse the natural language input and convert the natural language input into a format understandable by the grasp selector 406 and/or other components of the constrained object parameter generator 200. This format can include the indication of the target object and the instruction for manipulating the target object.

In some embodiments, the LLM can break the natural language input into a plurality of actionable components. The actionable components can include: a string that indicates the constrained object, a task type, a motion magnitude indicating the degrees or and/or length of motion, a wrench amount, and/or an initial direction of motion. In one example, the LLM can receive the natural language input “turn the yellow ball valve by 45 degrees clockwise.” For this example, the string that indicates the constrained object can be “yellow ball valve lever,” the task type can be a ball valve task type, the motion magnitude can be 45 degrees, the wrench amount can be a pre-defined force (e.g., 30 Newtons) when not specified by the natural language input, and the initial direction of motion can be clockwise. The input interpreter 402 can prompt the LLM to extract some or all of the above actionable components from the natural language input. If the LLM is not able to extract sufficient data from the natural language input, the LLM can generate one or more clarifying questions to prompt the user to provide additional information.

In some embodiments, a remote device (e.g., the remote device 40 shown and described above in FIG. 4) can display a camera image in a task location window (e.g., the task location window 46 shown and described above in FIG. 4). The user can select a target object from the camera image, for example, by tapping on the target object within the task location window. The user can also input the instruction for manipulating the target object via the task location window, for example, by selecting the instruction for manipulating from a list of instructions, swiping the task location window in a direction for moving the target object, entering the instructions for manipulating the target object via an on-screen keyboard, etc. As one example, the user can tap on a yellow handle in the task location window and entering +45 degrees as a command to rotate the identified yellow handle in a user interface box displayed within a user interface (e.g., the user interface 42 shown and described above in FIG. 4).

In some embodiments, the remote device can display a simulated movement of the target constrained object. The remote device can display the simulated movement on a screen of the user interface (e.g., within the task location window or within a separate window). As described herein, the constrained object parameter generator 200 can be configured to simulate movement of the target constrained object based on the set of parameters 204, which can be displayed on the remote device. For example, with reference to FIG. 3, the simulated movement can include the wheel lever spinning, the door opening, etc. In some embodiments, the simulated movement can be displayed to show different ways in which the target constrained object can move, such as the wheel spinning in two different directions, or the door either opening normally or sliding (like a pocket door), etc. The user can select one of the different types of simulated movement of the constrained target object and use this user selection to form part of the request.

The semantic model generator 404 is configured to receive the perception data 202 and generate a semantic model of one or more constrained objects within an environment (e.g., the environment 2 shown and described in FIG. 1). The semantic model of a constrained object can help the grasp selector 406 determine how to grasp the target object. In some embodiments, the perception data can include image data of the environment captured by a camera (e.g., the camera 31 shown and described above in FIG. 1) and/or other sensor data, such as depth data, generated by a vision system (e.g., the vision system 30 shown and described above in FIG. 1), such as RADAR, LIDAR, LADAR, light scanner, time-of-flight sensor, or any other 3D volumetric image sensor or generated by other sensor(s) of the robot.

The semantic model generator 404 can identify the portion(s) of the perception data 202 that correspond to different parts of the constrained object(s). For example, the semantic model generator 404 can identify the portion(s) of the constrained object within the perception data that correspond to a handle and/or other graspable portion(s) of the constrained object.

In some embodiments, the semantic model generator 404 can apply one or more segmentation methods to the perception data 202 to identify different portions of the constrained object (e.g., the handle and the remainder of the object). The semantic model generator 404 can apply computer vision algorithms to determine the principal axes of the constrained object, identify where the handle is attached to the remainder of the object, and any other relevant geometrical properties of the constrained object.

In some embodiments, the segmentation method can include segment anything model (SAM). However, aspects of this disclosure are not limited to using SAM as the segmentation method and any other segmentation method can be used without departing from aspects of this disclosure. The semantic model generator 404 can employ the segmentation method to mask out pixels from an image included in the perception data 202 corresponding to a particular object within the image. In some embodiments, the semantic model generator 404 can provide a point in the image (e.g., received via a touch input selecting a target object within the task location window) or a text description (e.g., the string that indicates the constrained object extracted using the LLM).

In some embodiments, the semantic model generator 404 can also classify the one or more constrained objects into one or more predefined categories. The semantic model of a constrained object can include the classification of the object in certain embodiments. Example categories that can be used for object classifications can include, for example: doors, switches, levers, shutters, ball valves, drawers, sliding doors, cranks, wheels, knobs, etc.

In some embodiments, the categories can have a higher level of generality, such that the constrained objects are classified based on the constrained object's degrees of freedom of movement. For example, this can include classifying objects as slidable objects, rotatable objects, or other high-level categories that identify the degrees of freedom of movement for the constrained object.

Although the semantic model generator 404 is included in the constrained object parameter generator 200 in the embodiment illustrated in FIG. 4, aspects of this disclosure are not limited thereto. In some embodiments, the constrained object parameter generator 200 may distribute the task of determining the semantic model to another computing device. For example, the constrained object parameter generator 200 may provide the perception data to the other computing device and receive the semantic model from the other computing device. The other computing device may include one or more programmable processors that are configured to communicate with the data processing hardware of the robot. In some applications, it may be more efficient to distribute the task of determining the semantic model (or other tasks) to programmable processor(s) that are external to the robot, for example, to provide additional processing power than is available on-board the robot.

The grasp selector 406 is configured to receive the semantic model of the one or more constrained objects in the environment from the semantic model generator 404 and the instructions for manipulating the target constrained object from the input interpreter 402. The grasp selector 406 can determine a location for the robotic arm of the robot to interact with the constrained object based on the semantic model and the request. In some embodiments, the robot interacting with the constrained object can include, for example, grasping, holding, supporting, inserting another object into, cleaning, etc. the constrained object.

When manipulating the target constrained object involves the robotic arm grasping the constrained object, the location for the robotic arm of the robot to interact with the target constrained object can include a location for the robotic arm to grasp the constrained object. Although this disclosure discusses grasping a constrained object as an example of a location for interacting with the constrained object, in some embodiments, the techniques described herein for determining a location for grasping the constrained object can also be modified for other types of manipulating constrained objects without departing from this disclosure.

The grasp selector 406 can identify the target constrained object in the semantic model received from the semantic model generator 404. In some embodiments, the grasp selector 406 can identify where the handle and/or other graspable portion of the constrained object is attached to the remainder of the constrained object, identify a location for the robotic arm to interact with the constrained object, identify what are the different axes of the constrained object, identify an axis of rotation of the constrained object, identify an axis of the constrained object that can be grasped, etc.

In some embodiments, the grasp selector 406 can receive the segmented pixels from the SAM of the semantic model generator 404 and identify a corresponding point cloud region from the perception data 202. In some embodiments, the point cloud can be generated by a time-of-flight sensor, although point clouds generated using other sensors can also be used without departing from aspects of this disclosure. The grasp selector 406 can identify the principal axes of the constrained object from the point cloud region. With reference back to the example natural language input “turn the yellow ball valve by 45 degrees clockwise,” the grasp selector 406 can determine which principal axis corresponds to the length of the handle. The grasp selector 406 can further identify the two ends of the handle and determine which end of the handle is connected to the remainder of the ball valve (also referred to as the “connected end”) and which end of the handle is free (or simply the “free end”).

The grasp selector 406 can also determine a location at which an articulated arm (e.g., the articulated arm 20 shown and described above in FIG. 1 or 2) should grasp the handle of the target constrained object. The grasp selector 406 can also determine a pose of the articulated arm for grasping or otherwise interacting with the target constrained object based on the semantic model of the target constrained object.

In some embodiments, the grasp selector 406 can also resolve any ambiguities in the pose of the articulated arm for grasping or interacting with the target constrained object. For example, one ambiguity may include whether a gripper (e.g., the gripper 24 shown and described above in FIG. 1) should be flipped 180 degrees or not when grasping the target constrained object. Depending on the number of joints in the articulated arm, there may also be a plurality of articulated arm poses that can result in the same pose of the gripper, and thus, the grasp selector 406 can also resolve any ambiguities in the articulated arm pose associated with grasping the target constrained object. In some embodiments, the grasp selector 406 can resolve any ambiguities based on the semantic model of the target constrained object, any limits associated with the articulated arm joints, the capabilities (e.g., maximum force that can be applied) of actuators (e.g., the actuators 25 shown and described above in FIG. 1) of the articulated arm.

Another ambiguity may include whether a particular grasp is a left-handed grasp or a right-handed grasp. Left vs right handed grasps may be substantially the same other than having a difference in whether the signs (e.g., positive or negative) of the applied wrench(es) (e.g., force(s) and torque(s)) applied are opposite or the same. The grasp selector 406 can be configured to resolve the ambiguity of whether a particular grasp is a left-handed grasp or a right-handed grasp and provide the determined handedness of the grasp as one of the parameters 204 output to a constrained manipulation controller (e.g., the constrained manipulation controller(s) 210 shown and described above in FIG. 2). In some embodiments, the grasp selector 406 can determine whether a particular grasp is a left-handed grasp or a right-handed grasp based on a current position of the hand (e.g., the hand 24 shown and described above in FIG. 1) and the target constrained object.

With reference back to the example natural language input “turn the yellow ball valve by 45 degrees clockwise,” the grasp selector 406 can determine whether to grasp the handle with a left-handed grasp or a right-handed grasp based on a current position of the hand and how the handle is connected to the remainder of the ball valve (e.g., the pose of the handle, the principal axis of the handle, and the identification of the connected end and the free end of the handle).

The body and foot placement generator 408 is configured to receive the determined grasp location and pose of the articulated arm from the grasp selector 406 and determine whether the robot needs to move to achieve the determined grasp location and pose of the articulated arm. In the event that the robot needs to move, the body and foot placement generator 408 can determine where to place a body (e.g., the body 13 shown and described above in FIG. 1) and/or one or more feet (e.g., the feet 19 shown and described above in FIG. 1) of the robot based on the received grasp location and pose of the articulated arm. For example, the body and foot placement generator 408 can determine a pose for each of the body and the legs of the robot that place the robot in position to achieve the grasp location and pose of the articulated arm.

The body and foot placement generator 408 can determine the pose(s) for the body and/or the legs of the robot to place the robotic arm in position to grasp and/or manipulate the target constrained object. In some embodiments, the body and foot placement generator 408 can determine the pose(s) for the body and/or the legs of the robot based on one or more of the following parameters: the reachability of the grasp pose (e.g., the volume of space that the robotic arm can reach based on the pose of the robot), the force manipulability achievable by the robotic arm (e.g., how much force can be exerted by the robotic arm, particularly along dimensions of interest) based on the poses of the body and/or legs of the robot, obstacles in the environment to be avoided, etc.

The parameter selector 410 is configured to receive the poses for the body and the legs of the robot from the body and foot placement generator 408 as well as the grasp location and pose of the articulated arm from the grasp selector 406 and generate the set of parameters 204 for performing post-grasp action (e.g., manipulating the target constrained object). The parameter selector 410 may also receive the semantic model of the target constrained object from the semantic model generator 404. The set of parameters 204 can include, for example, the task type, the motion magnitude, the motion direction, the initial direction of motion (e.g., the direction to apply wrench (e.g., force and/or torque) to manipulate the target constrained object), the wrench amount, the indication of whether the grasp is a left-handed grasp or a right-handed grasp, and/or the determined grasp location and pose of the articulated arm. The parameter selector 410 is configured to provide the set of parameters 204 to the constrained manipulation controller(s), which in turn are configured to control movement of the robot and/or the articulated arm to manipulate the constrained object based on the set of parameters 204.

In some embodiments, the parameter selector 410 can receive the task type, the motion magnitude, the motion direction, the initial direction of motion (e.g., the direction to apply wrench to manipulate the target constrained object), and/or the wrench amount from the input interpreter 402. The parameter selector 410 can receive the indication of whether the grasp is a left-handed grasp or a right-handed grasp and the determined grasp location and pose of the articulated arm from the grasp selector 406 and/or the body and foot placement generator 408.

In some embodiments, the parameter selector 410 may be able to identify the initial direction to apply wrench based on the semantic model of the target constrained object. For example, when the constrained object is a switch, the semantic model may include an axis of rotation of the switch and the current state of the switch, the parameter selector 410 can determine the initial direction to flip the switch from its current state.

In some embodiments, the task type may include: a rotation task (e.g., manipulating a door, ball valve, switch, crank, lever, etc.) or a linear task (e.g., manipulating a drawer, shutter, sliding door, etc.). In some embodiments, the task type may include more granular task types corresponding to the type of the target constrained object to be manipulated. The constrained object type can include one of: doors, switches, levers, shutters, ball valves, drawers, sliding doors, cranks, etc.

In some embodiments, the constrained object parameter generator 200 can be configured to simulate motion of the target constrained object based on the set of parameters 204. The constrained object parameter generator 200 can cause the remote device to display a simulated movement of the target constrained object, for example, within the task location window. The user can then select whether to proceed with manipulating the target constrained object based on the displayed simulated movement.

Because some or all of the set of parameters 204 may be determined by the input interpreter 402, the semantic model generator 404, the grasp selector 406, and/or the body and foot placement generator 408, in some embodiments, the constrained object parameter generator 200 may not include a parameter selector 410. For example, the constrained object parameter generator 200 can simply output the set of parameters 204 directly to the constrained manipulation controller(s) without using a parameter selector 410.

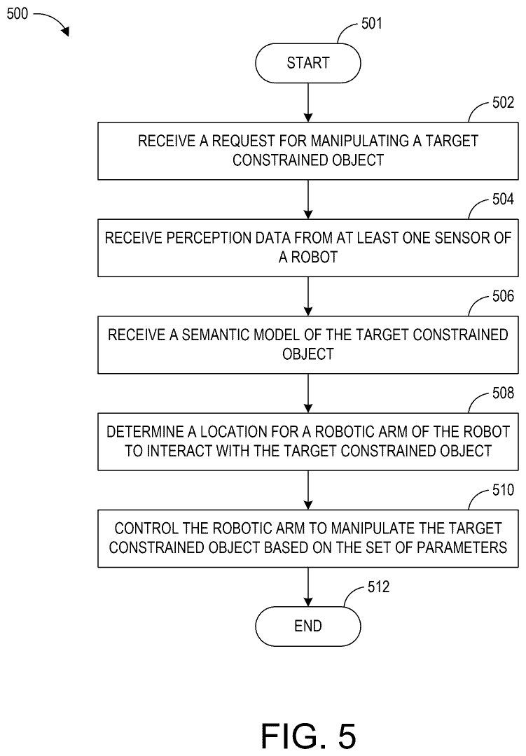

FIG. 5 illustrates a method 500 for manipulating a target constrained object. One or more blocks of the method 500 may be implemented, for example, by data processing hardware of a robot (e.g., the robot 10 shown and described above in FIG. 1 or 2), such as the data processing hardware 36 or the arm controller 100 of FIG. 1. The method 500 begins at block 501.

At block 502, the data processing hardware receives a request (e.g., the request 44 shown and described above in FIG. 1, 2, or 4) for manipulating a target constrained object. As described herein, the target constrained object may be an object that is constrained in at least one degree of freedom (DoF) of movement. The request can include an indication of the target object and an instruction for manipulating the target object.

At block 504, the data processing hardware receives perception data (e.g., the perception data 202 shown and described above in FIG. 2 or 4) from at least one sensor of a robot. The perception data can include data indicative of the target constrained object.

At block 506, the data processing hardware receives a semantic model of the target constrained object generated based on the perception data. Depending on the embodiment, the semantic model can be generated by the data processing hardware or can be generated by an external computing device and received by the data processing hardware from the external computing device. In some embodiments, the request includes natural language and the data processing hardware (or the other computing device) can parse the natural language using a large language model to generate an indication of the target object and an instruction for manipulating the target object.

At block 508, the data processing hardware determines a location for a robotic arm (e.g., the robotic arm 20 shown and described in FIG. 1 or 2) of the robot to interact with the target constrained object based on the semantic model and the request. In some embodiments, the data processing hardware can also determine a pose for the robotic arm to interact with the target constrained object at the determined location. In some embodiments, the location for the robotic arm to interact with the target constrained object is a location for the robotic arm to grasp the target constrained object.

At block 510, the data processing hardware controls the robotic arm to manipulate the target constrained object based on the location for the robotic arm to interact with the target constrained object. In some embodiments, prior to or in parallel with block 510, the data processing hardware can control the placement of the robot body and feet/legs. For example, if the robot is not in already in a pose that allows the robotic arm to manipulate the constrained object, the data processing hardware can position the robot in a pose that enables the robotic arm to interact with the constrained object.

The data processing hardware may also control the robotic arm to manipulate the target constrained object based on the request. In some embodiments, the data processing hardware can determine a set of parameters (e.g., the set of parameters 204 shown and described above in FIG. 2 or 4) for manipulating the target constrained object based on the location for the robotic arm to grasp the target constrained object. The data processing hardware can provide the set of parameters to one or more constrained manipulation controller(s) (e.g., the constrained manipulation controller(s) 210 shown and described above in FIG. 2), which can generate instructions (e.g., the instructions 206 shown and described above in FIG. 2) for controlling the robotic arm to manipulate the target constrained object. The method 500 ends at block 512.

As described herein, aspects of this disclosure can fully automate (or increase the level of automation) grasping and post-grasp parameter selection for manipulation constrained objects, which are an important class of manipulation tasks. This can involve an automated pipeline (as shown in FIG. 4) that can provide a number of advantages over other techniques.

One advantage is a higher chance of success associated with automated grasps. The automated grasps achieved using the techniques described herein lead to better, higher quality grasps compared to teleoperation or semi-automated grasping techniques, resulting in a higher chance of overall task success.

Another advantage is faster operation compared to other techniques. Other grasping techniques are typically driven by human operators which can often be very slow, especially in industrial environments with hard to grasp objects. The automated grasping pipeline described herein can significantly speed up the grasping process.

Still another advantage is increased repeatability. The automated grasping techniques described herein can significantly increase the grasp repeatability over human-driven grasp solutions.

The disclosed techniques can also advantageously be integrated into autonomous missions. Other teleoperation or semi-automated grasp techniques pose a major challenge for integrating these tasks into fully autonomous robot missions. The techniques described herein enable manipulation of constrained objects to be used in fully autonomous robot operations that require little to no human input.

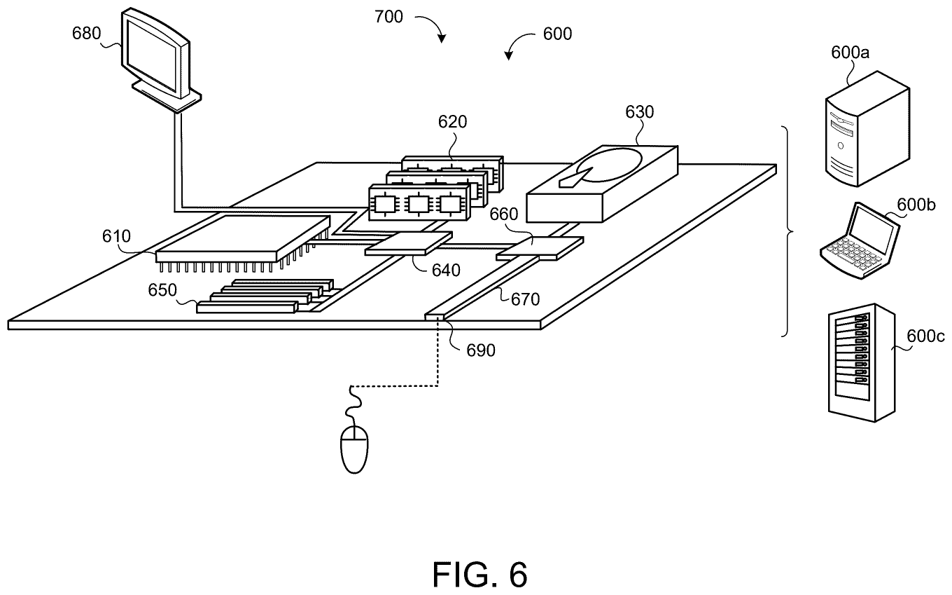

FIG. 6 is a schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low-speed interface/controller 660 connecting to a low-speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high-speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 620, the storage device 630, or memory on processor 610.

The high-speed controller 640 manages bandwidth-intensive operations for the computing device 600, while the low-speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. A processor can receive instructions and data from a read only memory or a random-access memory or both. The essential elements of a computer are a processor for performing instructions and one or more memory devices for storing instructions and data. A computer can include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A method, comprising:
receiving, by data processing hardware of a robot, a request for manipulating a target constrained object;
receiving, from at least one sensor of the robot, perception data indicative of the target constrained object;
receiving, by the data processing hardware, a semantic model of the target constrained object generated based on the perception data;
determining, by the data processing hardware, a location for a robotic arm of the robot to interact with the target constrained object based on the semantic model and the request; and
controlling, by the data processing hardware, the robotic arm to manipulate the target constrained object based on the location for the robotic arm to interact with the target constrained object.

2. The method of claim 1, wherein the target constrained object is constrained in at least one degree of freedom (DoF) of movement.

3. The method of claim 1, wherein the request comprises an indication of the target constrained object and an instruction for manipulating the target constrained object.

4. The method of claim 1, wherein the request includes natural language, the method further comprising:
parsing the natural language using a large language model to generate an indication of the target constrained object and an instruction for manipulating the target constrained object.

5. The method of claim 1, further comprising:
displaying a camera view received from a camera of the robot on a screen of a remote device;
receiving the request as an input of the remote device; and
displaying, on the screen, a simulated movement of the target constrained object.

6. The method of claim 1, wherein receiving the semantic model comprises determining, by the data processing hardware, the semantic model by:
identifying a graspable portion of the target constrained object within the perception data and identifying a location where the graspable portion is attached to a remainder of the target constrained object;
identifying a plurality of axes of the target constrained object;
identifying an axis of rotation of the target constrained object; and/or
identifying an axis of the target constrained object that can be grasped.

7. The method of claim 1, wherein receiving the semantic model comprises determining, by the data processing hardware, the semantic model by:
applying segmentation to the perception data to identify different portions of the target constrained object; and
applying a computer vision algorithm to determine a set of principal axes of the target constrained object, identify where a handle is attached to a remainder of the target constrained object, and identify one or more other geometrical properties of the target constrained object.

8. The method of claim 1, further comprising:
determining a pose of the robotic arm for grasping the target constrained object based on the semantic model.

9. The method of claim 8, further comprising:
resolving one or more ambiguities in the pose of the robotic arm for grasping the target constrained object based on the semantic model, one or more limits associated with joints of the robotic arm, and/or capabilities of actuators of the robotic arm,
wherein one or more ambiguities comprise whether a gripper of the robotic arm can interact with the target constrained object in a plurality of different poses and/or a plurality of poses of the robotic arm.

10. The method of claim 1, further comprising:
determining a pose for the robot based on the location for the robotic arm to interact with the target constrained object,
wherein controlling the robotic arm to manipulate the target constrained object is further based on the pose for the robot, and
wherein the pose for the robot comprises a pose for a body of the robot and a pose for one or more legs of the robot.

11. The method of claim 1, further comprising:
determining a set of parameters for manipulating the target constrained object based on the location for the robotic arm to interact with the target constrained object,
wherein controlling the robotic arm to manipulate the target constrained object is further based on the set of parameters, and
wherein the set of parameters comprises an initial direction to apply wrench to manipulate the target constrained object and/or a task type associated with the target constrained object.

12. A legged robot comprising:
a body;
a robotic arm configured to manipulate a target constrained object;
two or more legs coupled to the body;
at least one sensor configured to generate perception data; and
a control system in communication with the body and the robotic arm, the control system comprising data processing hardware and memory hardware in communication with the data processing hardware, the memory hardware storing instructions that when executed on the data processing hardware cause the data processing hardware to:
receive a request for manipulating the target constrained object;
receive the perception data from the at least one sensor, the perception data indicative of the target constrained object;
receive a semantic model of the target constrained object generated based on the perception data;
determine a location for the robotic arm to interact with the target constrained object based on the semantic model and the request; and
controlling the robotic arm to manipulate the target constrained object based on the location for the robotic arm to interact with the target constrained object.

13. The robot of claim 12, wherein the target constrained object is constrained in at least one degree of freedom (DoF) of movement.

14. The robot of claim 12, wherein the request comprises an indication of the target constrained object and an instruction for manipulating the target constrained object.

15. The robot of claim 12, wherein the request includes natural language, and wherein the instructions further cause the data processing hardware to:
parse the natural language using a large language model to generate an indication of the target constrained object and an instruction for manipulating the target constrained object.

16. The robot of claim 12, further comprising:
a camera,
wherein the instructions further cause the data processing hardware to:
display a camera view received from the camera on a screen of a remote device;
receive the request as an input of the remote device; and
display, on the screen, a simulated movement of the target constrained object.

17. The robot of claim 12, wherein receiving the semantic model comprises determining the semantic model by:
identifying a graspable portion of the target constrained object within the perception data and identifying a location where the graspable portion is attached to a remainder of the target constrained object;
identifying a plurality of axes of the target constrained object;
identifying an axis of rotation of the target constrained object; and/or
identifying an axis of the target constrained object that can be grasped.

18. The robot of claim 12, wherein the instructions further cause the data processing hardware to:
determine a set of parameters for manipulating the target constrained object based on the location for the robotic arm to interact with the target constrained object,
wherein controlling the robotic arm to manipulate the target constrained object is further based on the set of parameters.

19. The robot of claim 18, wherein the set of parameters comprises an initial direction to apply wrench to manipulate the target constrained object and/or a task type associated with the target constrained object.

20. A non-transitory computer-readable medium having stored therein instructions that, when executed by data processing hardware of a robot, cause the data processing hardware to:
receive a request for manipulating a target constrained object;
receive, from at least one sensor of the robot, perception data indicative of the target constrained object;
receive a semantic model of the target constrained object generated based on the perception data;
determine a location for a robotic arm of the robot to interact with the target constrained object based on the semantic model and the request; and
control the robotic arm to manipulate the target constrained object based on the location for the robotic arm to interact with the target constrained object.

21. The non-transitory computer-readable medium of claim 20, wherein the target constrained object is constrained in at least one degree of freedom (DoF) of movement.

22. The non-transitory computer-readable medium of claim 20, wherein the request comprises an indication of the target constrained object and an instruction for manipulating the target constrained object.
